(19) United States
(12) Patent Application Publication
(10) Pub. No.: US 2018/0055015 A1
(43) Pub. Date: Mar. 1, 2018

(54) Pet Leash Cutter

(71) Applicant: Oleg Lee, Buffalo Grove, MA (US)

(72) Inventor: Oleg Lee, Buffalo Grove, MA (US)

(21) Appl. No.: 15/253,578

(22) Filed: Aug. 31, 2016

(51) Int. Cl. A01K 27/00; B26B 3/00

(52) U.S. Cl. CPC A01K 27/00; B26B 3/00

(57) ABSTRACT

A cutter for dog or other animal leashes for use freeing pets in the event of an emergency in which the leash has become caught. The leash cutter comprises a flat body portion containing a protected blade, access to the blade being provided by means of an elongated channel into which a shape blade to cut the leash fits. A holder is provided for releasable mounting on a dog leash at a convenient location for easy access in the event of an emergency.

### BACKGROUND

### Field of the Invention

The present invention is directed to dog or other animal and/or pet leashes, and more particularly, to a device to cut said leashes in the event of an emergency.

### Background of the Invention

Use of leashes by dog-walkers and others to control their pets is well recognized and established in society and the art. Such leashes are often made of strong, pliable, but hard-to-rip or otherwise break materials such as nylon, rope, or hemp. Such leashes are commonly used when pets are taken out of the home, both to control the animals as well as to keep them and those in their environment safe. In many areas, such as in cities or on public property, the use of leashes on animals, specifically on dogs, has become mandatory. However, use of leashes can be the cause of dangerous situations involving the leashed animals and their handlers, as leashes have a tendency to snag on objects and become caught or stuck. In these instances, leashes may result in serious injury or even death to the animal attached to them.

For example, leashes can become caught in moving parts or around solid objects. It is well documented in recent news that leashes can become caught in elevator doors, escalators, revolving doors, or other common moving or mechanical devices. Leashes can become wrapped around vehicle wheels or axels, or trapped in vehicle doors, causing serious injury or death to the leashed pet as a result of dragging, choking, or breaking bones through sudden pulls to the leash, which is attached to the pet, often at the neck. Even if a pet with a caught leash is able to free itself, it may still be injured and the event is necessarily traumatic for pet and owner alike. All animals restrained with leashes may suffer the same types of accidents.

Most leashes are simple straps. They do not commonly have an easy-release mechanism to allow a pet to be quickly freed. Retractable leashes are commonly long and easily wrapped around or caught on objects or obstacles than conventional leashes. Prior art fails to provide an effective solution to avoid or cut down on serious injuries that can occur when such leashes get caught on, in, or around obstacles that can provide health hazard to the leashed animal.

No prior art has satisfactorily devised a solution to this problem. Prior art for vehicle seatbelt cutters do not adequately address the present concern as they are not intended to be transported attached to the leash itself, and therefore must be carried in the hand or in a purse, backpack, or other transportation means. As a result, a vehicle seatbelt cutter would be difficult to access in the case of an emergency in which the pet's leash was caught, and where time is necessarily of the essence to free the trapped animal before it suffers injury or death. Further, the shape of such devices is often ill-suited to the smaller, sometimes rounded shape of pet leashes.

### SUMMARY OF THE INVENTION

The object of the present invention is to provide easy and convenient access to a device used in emergencies to cut through and release pet attached to a leash or similar animal-restraint harness. According to the present invention, the device comprises a general flat body portion with a hand grip area, and having an elongated channel therein, dimensioned in both length and width so as to receive a leash edgewise for cutting purposes. Disposed within the elongated channel is a blade with an outwardly-presented cutting edge, within the thickness of the flat body portion. The device also includes a hole in which it may be attached to the leash for easy use in an emergency.

### BRIEF REFERENCE TO THE DRAWINGS

FIG. 1 of the accompanying drawings is a front perspective view of the leash cutter in accordance with the specific most preferred embodiment of the invention;

FIG. 2 is a front view of the device of FIG. 1.

FIG. 3 is a depiction of a dog whose leash has become caught in elevator doors.

FIG. 4 is a depiction of the preferred embodiment being used to free a dog whose leash has become caught in elevator doors.

### SPECIFIC DESCRIPTION OF THE PREFERRED EMBODIMENT

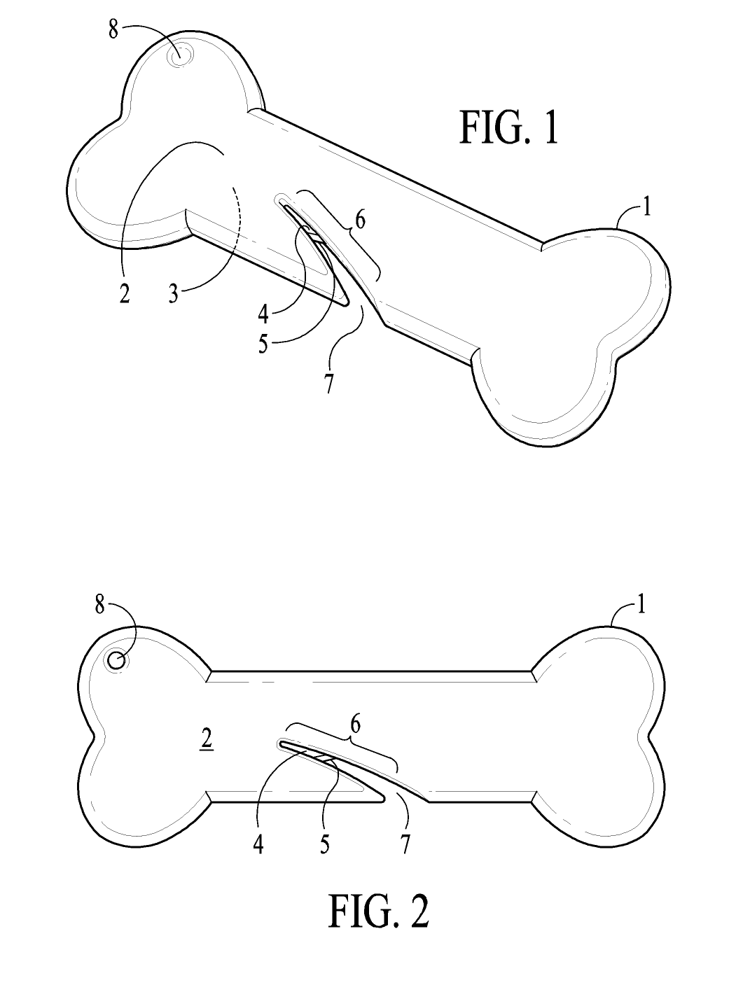

FIGS. 1 and 2 show a preferred embodiment of a pet leash cutter. The device according to the present invention comprises a body portion 1 constituted by two essentially similar flat laminated halves 2, 3, fastened together by a solvent welding or similar means to form the flat, generally rectangular body portion 1, including whimsical shapes such as a cartoon dog-bone silhouette, as in the depicted preferred embodiment. The body portion 1 is preferably made of strong plastic or metallic material, e.g. ABS plastic, aluminum, or the similar suitable material, and can be in any color. Between the flat halves 2, 3, there is provided a rectangular steel blade 4 having a cutting edge 5. It may conveniently be fabricated in two similar flat halves 2, 3, laminated together with the cutting edge 5 sandwiched between them, as by solvent welding, heat sealing, ultrasound welding, or similar suitable means.

The body portion 1 is formed with an elongated channel 6 extending at an approximately 20-degree angle from the outside edge, the open mouth 7 thereof being bounded by a smooth, curved body surface to provide easy access for a leash to be inserted. The cutting blade 5 is preferably also disposed near the center of the body portion 1 of the device, to be surrounded by sufficient structural material to withstand the necessary cutting forces exerted thereon.

The width of channel 6 is appropriately chosen to readily accommodate the thickness of a pet leash, but to allow only very restricted up and down movement of a leash received therein. A portion of the cutting edge 5 of the blade 4 is disposed at the termination of channel 6, to effect cutting of a leash drawn against the cutting edge 5 of the steel blade 4. The channel 6 is sufficiently narrow that cutting edge 5 of the blade is effectively shielded for extra safety when not in use. Above the open mouth 7 of channel 6 there is provided a hole 8 suitably dimensioned to be attached to a clip, carbineer, or other suitable attachment means, so that the cutter can be attached at a convenient point on the leash to be conveniently and safely. Further, the generally rectangular body portion 1 allows it to act as a handle means whereby it may be firmly and positively gripped for operation. It will also be appreciated that the device is mountable on a leash at a convenient angle and location, and is equally usable by either right-handed or left-handed users.

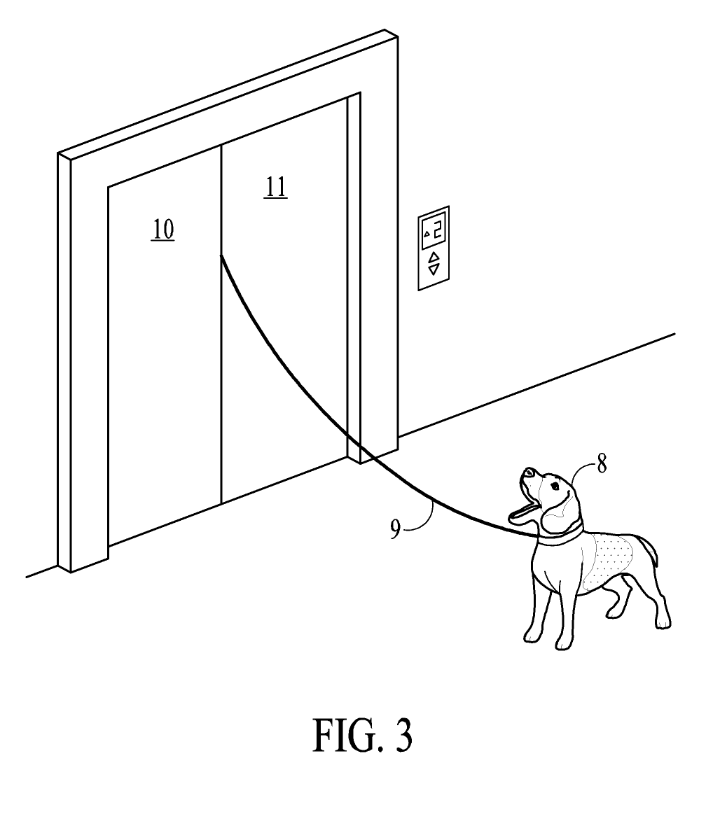

FIG. 3 depicts a dog 8 restrained by a leash 9 whose leash has become trapped between the two halves 10,11 of an elevator door.

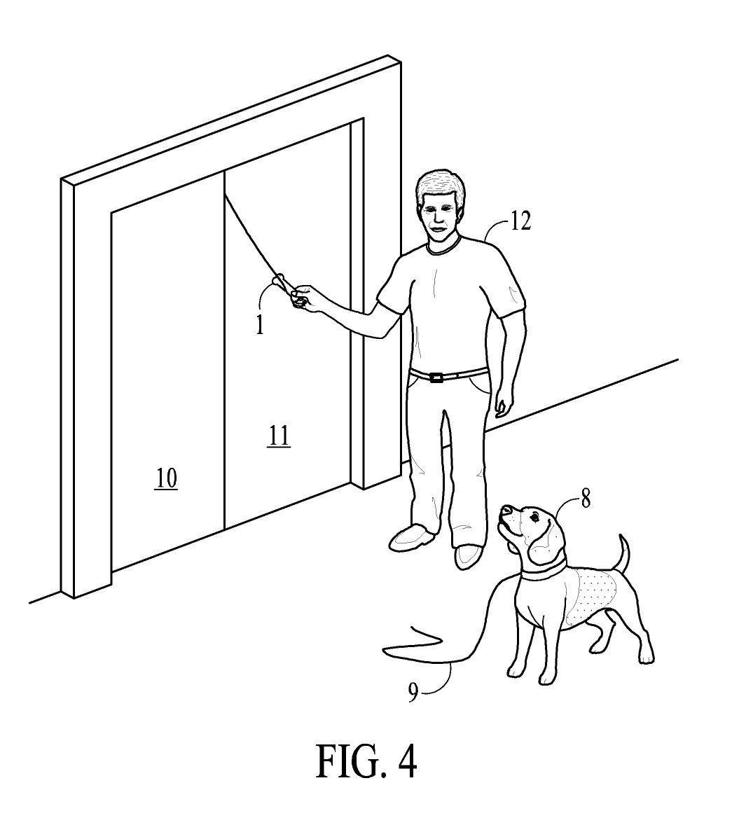

FIG. 4 depicts a dog 8 whose owner 12 has severed the leash 9 through use of the preferred embodiment of the pet leash cutter.

Whilst a specific preferred embodiment of the invention has been described and illustrated herein, it will be appreciated that this is for the purposes of illustration and exemplification only, and the scope of the invention is limited only by the scope of the appended claims.

I claim:

1. A device for cutting and severing leashes and restraint harnesses to free a pet constrained thereby, said device comprising:
a generally flat body portion having a hand grip area;
an open-ended elongated channel therein, said channel being dimensioned in both length and width so as to receive a leash for cutting purposes;
a blade having a cutting edge disposed in said channel, the cutting edge thereof being disposed within the thickness of the flat body portion, said cutting edge exposed at an inner edge of said channel.

2. A device according to claim 1 wherein the body portion includes a gripping means in the form of an aperture disposed near the open end of the channel, adapted to receive an operator's finger therein for positive gripping and pulling the device relative to a leash to be cut.

3. A device according to claim 1 of generally rectangular overall shape, the cutting edge of the blade being disposed near the center of the rectangle so as to provide structural strength for the leash cutting operation therewith.

4. A device according to claim 1 formed in the shape of a cartoon dog bone.

5. A device for cutting and severing leashes and restraint harnesses to free a pet constrained thereby, said device comprising:
a generally flat body portion having a hand grip area;
an open-ended elongated channel therein, said channel being dimensioned in both length and width so as to receive a leash for cutting purposes;
a first blade having a cutting edge disposed in said channel, the cutting edge thereof being disposed within the thickness of the flat body portion, said cutting edge exposed on one side of said channel.
a second blade having a cutting edge disposed in said channel, the cutting edge thereof being disposed within the thickness of the flat body portion, said cutting edge exposed at the opposite side of said channel roughly parallel to said first blade.
